(19) United States
(12) Patent Application Publication
(10) Pub. No.: US 2025/0097798 A1
(43) Pub. Date: Mar. 20, 2025

(54) ELECTRONIC APPARATUS, CONTROL METHOD THEREOF, AND NON-TRANSITORY COMPUTER-READABLE STORAGE MEDIUM STORING A PROGRAM

(71) Applicant: CANON KABUSHIKI KAISHA, Tokyo (JP)

(72) Inventor: Chisei Sumita, Tokyo (JP)

(21) Appl. No.: 18/826,374

(22) Filed: Sep. 6, 2024

(30) Foreign Application Priority Data
Sep. 15, 2023 (JP) 2023-150288

(51) Int. Cl. H04W 36/08; H04W 36/30

(52) U.S. Cl. CPC H04W 36/08; H04W 36/304

(57) ABSTRACT

An electronic apparatus including: at least one memory and at least one processor which function as: a receiving unit configured to receive, from a first access point to which the electronic apparatus is currently connected, a change request of an access point serving as a connection destination from the first access point to a second access point; a control unit configured to perform control to change the connection destination from the first access point to the second access point based on the change request being received by the receiving unit; and a notification unit configured to make a notification that the connection destination has been changed when the connection destination is changed from the first access point to the second access point based on the change request.

### BACKGROUND OF THE INVENTION

### Field of the Invention

The present invention relates to an electronic apparatus capable of connections over a wireless LAN, a control method of the electronic apparatus, and a non-transitory computer-readable storage medium in which a program is stored.

### Description of the Related Art

In wireless LAN environments where electronic apparatuses are connected, there is a technique, in an extended service set (ESS) constituted by a plurality of access points (APs), for dynamically switching the connection destination AP such that the APs and a station (STA) can exchange data efficiently. When it is determined that the connection destination AP should be switched based on the congestion of the APs to which the STA is connected, the availability of other APs, radio wave conditions, and the like, the AP that is currently connected sends a connected AP change request to the STA. Upon receiving an AP change request, the STA can connect to the appropriate AP by switching the connection destination AP in accordance with the request.

Japanese Patent Laid-Open No. 2021-175068 discloses the following as processing for a router having AP functionality to make a request, to a wireless child device that is currently connected, to change the connection destination. A mobile router (MR1) that can connect to a plurality of wireless child devices confirms whether the wireless child device terminals support IEEE 802.11v. Whether a wireless child device terminal supports IEEE 802.11v can be determined from an Association Request frame sent when the wireless child device terminal connects to MR1 wirelessly. If the wireless child device terminal supports IEEE 802.11v, a BSS Transition Management (BTM) Request frame is sent to the corresponding wireless child device terminal. A BSS Transition Candidate List Entries field of the BTM Request frame specifies a BSSID of a parent router RT2 as the connection destination. This prompts the child device terminal to switch the connection destination, and the wireless child device terminal switches the connection destination from MR1 to RT2 in accordance with the received BTM Request frame.

### SUMMARY OF THE INVENTION

The present invention provides an electronic apparatus that improves the convenience when an STA switches a connection destination AP, a control method for the electronic apparatus, and a non-transitory computer-readable storage medium in which a program is stored.

The present invention provides, in one aspect, an electronic apparatus comprising: at least one memory and at least one processor which function as: a receiving unit configured to receive, from a first access point to which the electronic apparatus is currently connected, a change request of an access point serving as a connection destination from the first access point to a second access point; a control unit configured to perform control to change the connection destination from the first access point to the second access point based on the change request being received by the receiving unit; and a notification unit configured to make a notification that the connection destination has been changed when the connection destination is changed from the first access point to the second access point based on the change request.

According to the present invention, it is possible to improve the convenience when an STA switches a connection destination AP.

Further features of the present invention will become apparent from the following description of exemplary embodiments with reference to the attached drawings.

### BRIEF DESCRIPTION OF THE DRAWINGS

FIG. 1 is a diagram illustrating a system configuration.

FIGS. 2A and 2B are diagrams illustrating the configuration of a multifunction peripheral device (MFP).

FIGS. 3A, 3B, and 3C are diagrams illustrating a console unit of the MFP.

FIGS. 4A and 4B are diagrams illustrating the configuration of a mobile terminal device.

FIG. 5 is a diagram illustrating the configuration of an access point (AP).

FIG. 6 is a sequence chart illustrating processing based on a request to change a connection destination from an AP.

FIGS. 7A and 7B are diagrams illustrating examples of screens displayed in the console unit of the MFP.

FIG. 8 is a flowchart illustrating an example of processing performed by the MFP in response to a request to change a connection destination.

FIG. 9 is a flowchart illustrating an example of processing performed by the MFP in response to a request to change a connection destination.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Incidentally, when an STA receives an AP change request and switches the connection destination AP in accordance with the request, a user may not be able to recognize that the connection destination AP of the STA has switched. What is needed, therefore, is an improvement in the convenience when an STA switches a connection destination AP.

According to the present disclosure it is possible to improve the convenience when an STA switches a connection destination AP.

### System Configuration

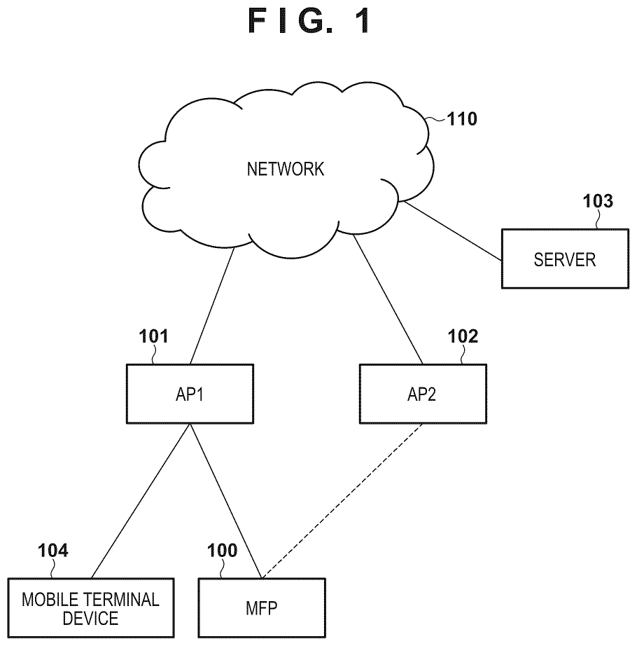

FIG. 1 illustrates an example of the configuration of a system according to the present embodiment. In one example, this system is a wireless communication system in which a plurality of communication devices can communicate with each other wirelessly. In the example illustrated in FIG. 1, a mobile terminal device 104 and a multifunction peripheral device (MFP) 100 serving as communication devices, access points AP101 and AP102, a DHCP server 103, and a network 110 are provided. Note that the AP 101 and the AP 102 may be denoted as “AP1” and “AP2”, respectively. The mobile terminal device 104 is a device having a wireless communication function that uses wireless LAN or the like. “Wireless LAN” may be called “WLAN” hereinafter. The mobile terminal device 104 may be a personal information terminal such as a personal digital assistant (PDA), a mobile phone (a smartphone), a digital camera, a personal computer, or the like.

The MFP 100 has a printing function, and may further have a reading function (a scanner), a fax function, a telephone function, and the like. The MFP 100 according to the present embodiment also has a communication function that enables wireless communication with the mobile terminal device 104. Although the present embodiment describes a case where the MFP 100 is used as an example, the configuration is not limited thereto. For example, a printing apparatus, a scanner apparatus, a projector, a mobile terminal, a smartphone, a laptop PC, a tablet terminal, a PDA, a digital camera, a music playback device, a television, a smart speaker, or the like, which has a communication function, may be used instead of the MFP 100. Note that “MFP” is an acronym for “Multi Function Peripheral”.

The AP101 is provided separately (outside) from the mobile terminal device 104 and the MFP 100, and functions as a WLAN base station device. A communication device having a WLAN communication function can communicate in WLAN infrastructure mode via the AP101. Note that access points may be called “APs” hereinafter. Infrastructure mode may also be called “wireless infrastructure mode”. The AP101 communicates wirelessly with a communication device that has permitted (authenticated) a connection to itself, and relays wireless communication between that communication device and other communication devices. The AP101 can, for example, be connected to a wired communication network, and can relay communication between a communication device connected to that wired communication network and another communication device wirelessly connected to the AP101.

The AP102 has the same functions as the AP101, and the MFP 100 switches its connection from the AP101 to the AP102 as necessary. The server 103 includes a DHCP server and a DNS server. The DHCP server connects to the MFP 100 via the AP101 and the network 110, and provides services to the MFP 100 by responding to requests from the MFP 100. Although FIG. 1 illustrates a configuration in which the DHCP server is connected as a device separate from the AP101 and the AP102, the configuration may be such that the AP101 and the AP102 have DHCP server functionality. Here, the network 110 may the Internet, or may be a private network in a business, a mobile phone network, or the like.

### External Configuration of MFP

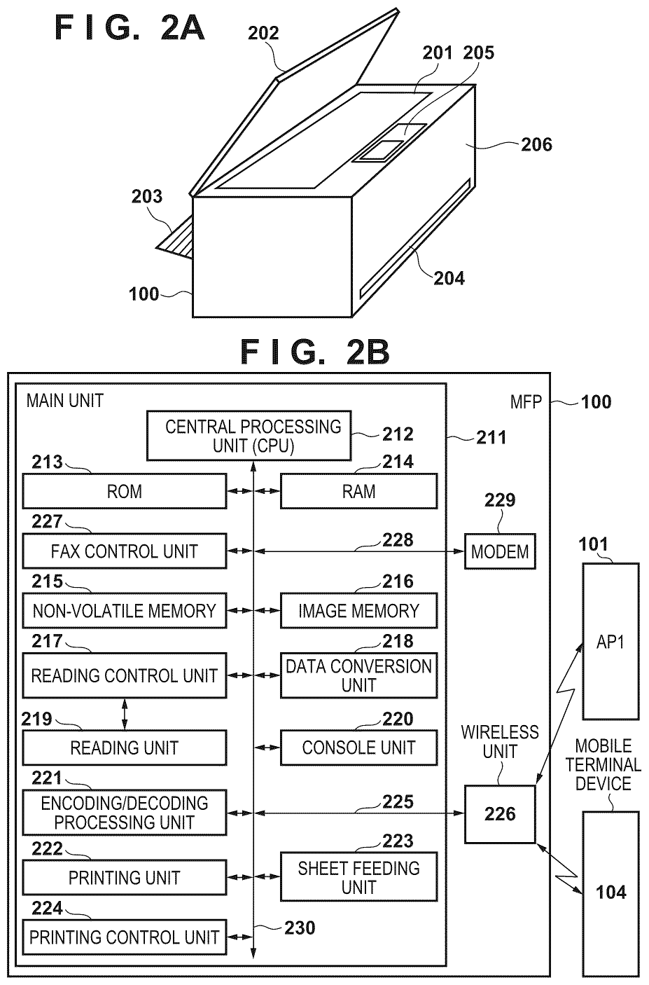

FIG. 2A illustrates an example of the external configuration of the MFP 100. The MFP 100 includes a document platform 201, a document cover 202, a printing paper insertion port 203, a printing paper discharge port 204, and a console unit 205, for example. The document platform 201 is a platform for placing a document to be read. The document cover 202 is a cover for securing a document placed on the document platform 201, and for ensuring that light from a light source that illuminates the document does not escape to the exterior when the document is being read. The printing paper insertion port 203 is an insertion port in which various sizes of paper can be set. The printing paper discharge port 204 is a discharge port for discharging paper which has been printed onto. Paper set in the printing paper insertion port 203 is conveyed one sheet at a time to a printing unit, where the paper is printed onto and then discharged from the printing paper discharge port 204. The console unit 205 is configured including keys such as character input keys, a cursor key, an OK key, a cancel key, and the like, as well as LEDs, an LCD, and the like, and is configured such that a user can launch the various functions of the MFP, manipulate various settings, and the like. The console unit 205 may also be configured including a touch panel display. The MFP 100 has a WLAN wireless communication function and therefore is configured also including a wireless communication antenna 206 for that wireless communication, although the antenna 206 is not necessarily visible from the exterior. Like the mobile terminal device 104, the MFP 100 can communicate wirelessly over the WLAN in frequency bands such as the 2.4 GHz band, the 5 GHz band, or the like.

### MFP Configuration

FIG. 2B illustrates an example of the configuration of the MFP 100. The MFP 100 is configured including a main unit 211 that performs main control of the device itself, and a wireless unit 226, which is a single communication module that performs WLAN communication using at least one common antenna. The main unit 211 merely indicates a block which includes functional blocks other than a modem 229 and the wireless unit 266. The MFP 100 is also configured including the modem 229 for wired communication, for example. The main unit 211 is configured including, for example, a CPU 212 (a central processing unit), a ROM 213, a RAM 214, a non-volatile memory 215, an image memory 216, a reading control unit 217, a data conversion unit 218, a reading unit 219, and an encoding/decoding processing unit 221. The main unit 211 also includes, for example, a printing unit 222, a sheet feeding unit 223, a printing control unit 224, a console unit 220, and a fax control unit 227. The functional units in the main unit 211 are connected to each other by a system bus 230 managed by the CPU 212. Additionally, the main unit 211 and the wireless unit 226 are connected, for example, by a dedicated bus 225, and the main unit 211 and the modem 229 are connected, for example, by a bus 228.

The CPU 212 is a system control unit including at least one processor, and controls the MFP 100 as a whole. The processing by the MFP 100 described below is implemented by the CPU 212 executing programs stored in the ROM 213, for example. Note that dedicated hardware for each process may be provided. The ROM 213 stores control programs executed by the CPU 212, embedded OS programs, and the like. In the present embodiment, the CPU 212 performs software control such as scheduling, task switching, and the like by executing each control program stored in the ROM 213 under the management of an embedded OS, which is also stored in the ROM 213.

The RAM 214 is constituted by an SRAM or the like. The RAM 214 stores data such as program control variables, data such as setting values registered by the user and management data of the MFP 100, and the like. In addition, the RAM 214 can be used as various types of working buffers. The non-volatile memory 215 is constituted by a memory such as a flash memory, for example, and continues to store data even when the MFP 100 is turned off. The image memory 216 is constituted by a memory such as a DRAM. The image memory 216 stores image data received through the wireless unit 226, image data processed by the encoding/decoding processing unit 221, and the like. Note that the memory configuration of the MFP 100 is not limited to the configuration described above. The data conversion unit 218 analyzes data in various formats, converts image data into printing data, and the like.

The reading control unit 217 controls the reading unit 219 (e.g., a contact-type image sensor (CIS)) to optically read a document placed on the document platform 201. The reading control unit 217 converts an image obtained by optically reading the document into electrical image data (an image signal) and outputs the image data. At this time, the reading control unit 217 may perform various types of image processing, such as binarization, half-tone processing, and the like before outputting the image data.

The console unit 220 is the console unit 205 described with reference to FIG. 2A, and displays items in a display under display control by the CPU 212, generates signals in response to accepting user operations, and the like.

The encoding/decoding processing unit 221 performs encoding processing, decoding processing, scaling processing, and the like on image data handled by the MFP 100 (JPEG, PNG, and the like).

The sheet feeding unit 223 holds sheets for printing. The sheet feeding unit 223 can supply sheets set therein under the control of the printing control unit 224. The sheet feeding unit 223 may include a plurality of sheet feeding units to hold a plurality of types of sheets in a single apparatus, and from which sheet feeding unit sheets are fed can be controlled under the control of the printing control unit 224.

The printing control unit 224 applies various types of image processing, such as smoothing processing, print darkness correction processing, color correction, and the like, to the image data to be printed, and outputs the processed image data to the printing unit 222. The printing unit 222 is configured to be capable of executing ink jet printing processing, for example, so that ink supplied from an ink tank is ejected from a print head and an image is recorded on a recording medium such as paper. Note that the printing unit 222 may be configured to be capable of executing other types of printing processing, such as electrophotographic printing. The printing control unit 224 can also periodically read out information on the printing unit 222 and update status information and the like stored in the RAM 214, including the remaining amount of the ink tank, the state of the print head, and the like.

The wireless unit 226 is a unit capable of providing a WLAN communication function, and is capable of providing functions equivalent to a combination with a WLAN unit 401 of the mobile terminal device 104, for example. In other words, according to the WLAN standard, the wireless unit 226 converts data into packets and sends the packets to other devices, and also restores packets from other external devices into the original data thereof and outputs the data to the CPU 212. The wireless unit 226 is capable of communicating as a station compliant with the IEEE 802.11 standard series. The wireless unit 226 is particularly capable of communicating as a station compliant with IEEE 802.11a/b/g/n/ac/ax. “Stations” may be called “STA” hereinafter. The wireless unit 226 is also capable of communicating as an STA that supports Wi-Fi Agile Multiband (registered trademark).

The wireless unit 226 supports IEEE 802.11ax, i.e., Wi-Fi 6 (registered trademark), and is capable of processing compliant with IEEE 802.11ax. In other words, the MFP 100 is capable of either or both of processing as an STA that supports (is compliant with) OFDMA, and operations (processing) as an STA that supports (is compliant with) TWT. “OFDMA” is an acronym for “Orthogonal Frequency-Division Multiple Access”. “TWT” is an acronym for “Target Wake Time”. Supporting TWT means that the timing of data communication from a parent device to the STA is adjusted. The wireless unit 226 (the MFP 100) serving as the STA shifts the communication function to a sleep state when there is no need to stand by for signal reception. This makes it possible to suppress power consumption. The wireless unit 226 also supports Wi-Fi 6E (registered trademark). In other words, the wireless unit 226 is also capable of communicating in the 6 GHz band (5.925 GHz to 7.125 GHz). Unlike the 5 GHz band, the 6 GHz band does not have a band in which Dynamic Frequency Selection (DFS) is performed. As such, in communication in the 6 GHz band, communication will not be cut off due to DFS standby time, which can be expected to improve the communication.

Note that the mobile terminal device 104 and the MFP 100 are capable of P2P (WLAN) communication based on WFD, and the wireless unit 226 has a software access point (software AP) function or a group owner function. In other words, the wireless unit 226 is capable of constructing P2P communication networks, setting channels to use in P2P communication, and the like.

### MFP Console Unit

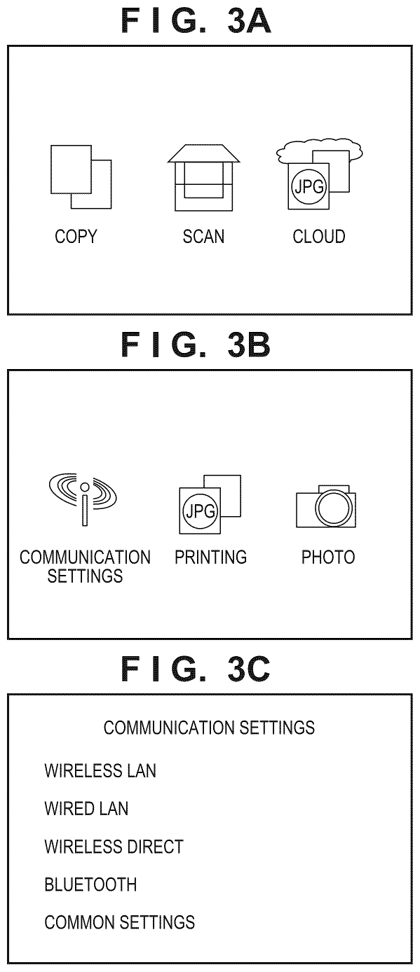

FIGS. 3A to 3C schematically illustrate examples of screens displayed in a display (a touchscreen) included in the console unit 220 of the MFP 100. FIG. 3A illustrates an example of a home screen displayed when the MFP 100 is turned on and operations such as printing, scanning, or the like are not underway (an “idle state” or a “standby state”). In FIG. 3A, display items indicating “copy”, “scan”, and “cloud” (menu items) are displayed. “Cloud” is a menu item related to a cloud function that uses Internet communication. Settings in the MFP 100 can be made, the execution of functions can be started, and the like by operating keys, the touch panel, or the like to select one of the menu items. The MFP 100 can seamlessly display a screen different from that illustrated in FIG. 3A by accepting an operation of a key, the touch panel, or the like in the home screen illustrated in FIG. 3A.

FIG. 3B is an example of the display of another part of the home screen, and is a screen transitioned to in response to an operation for displaying another page of the home screen (an operation for sliding to the left or the right) made in the state illustrated in FIG. 3A. In FIG. 3B, display items (menu items) indicating “communication settings”, “printing”, and “photo” are displayed. When one of these menu items is selected, the function corresponding to the selected menu item, i.e., one of the printing function, the photo function, and the communication settings, is executed.

FIG. 3C is an example of the display of a menu screen for the communication settings, displayed when “communication settings” has been selected in the screen illustrated in FIG. 3B. “Wireless LAN”, “Wired LAN”, “Wireless Direct”, “Bluetooth”, and “Common Settings” are displayed as menu items (options) in the communication settings menu screen. “Wireless LAN”, “Wired LAN”, and “Wireless Direct” are menu items for LAN settings, settings such as wired connection settings, settings for enabling and disabling a wireless infrastructure mode, settings for enabling and disabling a P2P mode such as WFD and software AP mode, and the like can be set using these items. When the “Wireless LAN” item is selected and the wireless LAN is enabled by a user operation, wireless infrastructure mode is enabled. When the “Wireless Direct” item is selected and wireless direct is enabled by a user operation, the P2P (WLAN) mode is enabled. A common settings menu for each connection format is also displayed in this screen. Furthermore, the user can set the frequency band, frequency channel, and the like of the wireless LAN from this screen.

### External Configuration of Mobile Terminal Device

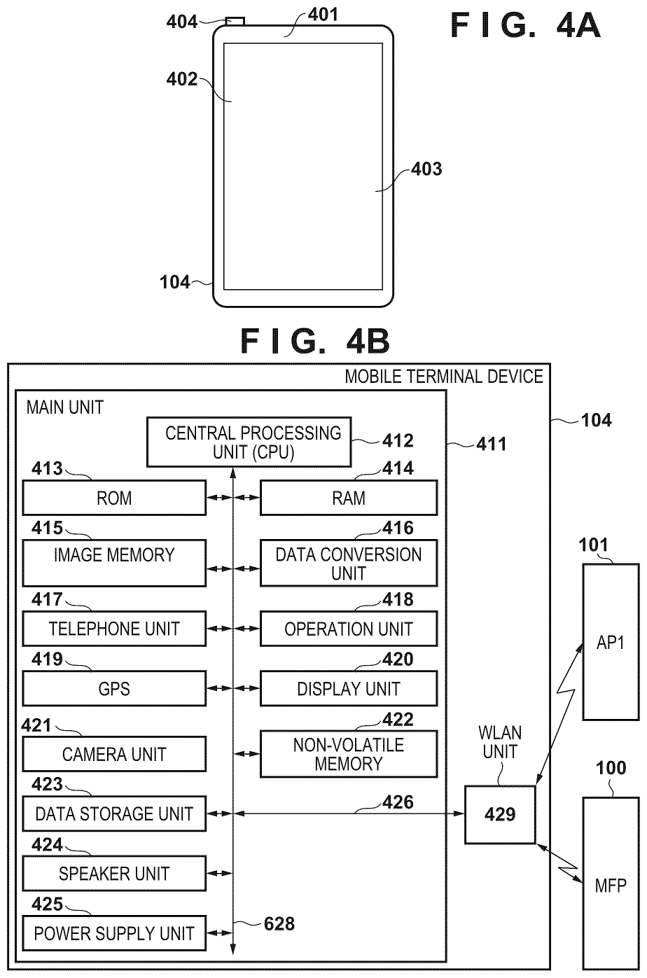

FIG. 4A is a diagram illustrating an example of the external configuration of the mobile terminal device 104. The present embodiment will describe a case where the mobile terminal device 104 is a typical smartphone, for example. Note that the mobile terminal device 104 is configured including a display unit 402, an operation unit 403, and a power key 404, for example. The display unit 402 is a display having a Liquid Crystal Display (LCD)-based display mechanism, for example. Note that the display unit 402 may display information using a Light Emitting Diode (LED) or the like, for example. The mobile terminal device 104 may also have a function for outputting information by audio in addition to or instead of the display unit 402. The operation unit 403 is configured including physical keys such as keys, buttons, and the like, a touch panel, and the like for detecting user operations. Note that in this example, the information display in the display unit 402 and the acceptance of user operations by the operation unit 403 are performed using a common touch panel display, and thus the display unit 402 and the operation unit 403 are implemented as a single device. In this case, for example, button icons or a software keyboard are displayed using a display function of the display unit 402, and the user touching those locations is detected using an operation reception function of the operation unit 403. Note that the display unit 402 and the operation unit 403 may be separate, and the hardware for display and the hardware for accepting operations may be provided individually. The power key 404 is a physical key for accepting user operations for turning the mobile terminal device 104 on or off.

The mobile terminal device 104 includes the WLAN unit 401, which provides WLAN communication functionality, but is not necessarily visible from the exterior. The WLAN unit 401 is configured to be capable of data (packet) communication in a WLAN system compliant with the IEEE 802.11 standard series (IEEE 802.11a/b/g/n/ac/ax and the like), for example. The wireless unit 226 is also capable of communicating as an AP that supports Wi-Fi Agile Multiband (registered trademark). However, the configuration is not limited thereto, and the WLAN unit 401 may be capable of communication in a WLAN system compliant with another standard. This example assumes that the WLAN unit 401 is capable of communicating in both the 2.4 GHz band and the 5 GHz band. The WLAN unit 401 is also assumed to be capable of communication based on WFD, communication using the software AP mode, communication using the wireless infrastructure mode, and the like. Operations performed in these modes will be described later.

### Configuration of Mobile Terminal Device

FIG. 4B illustrates an example of the configuration of the mobile terminal device 104. The mobile terminal device 104 includes a main unit 411 that performs main control of the device itself, and a WLAN unit 429 that performs WLAN communication, for example. The main unit 411 merely indicates a block which includes functional blocks other than the WLAN unit 429. The main unit 411 includes, for example, a CPU 412, a ROM 413, a RAM 414, an image memory 415, a data conversion unit 416, a telephone unit 417, a GPS 419, a camera unit 421, a non-volatile memory 422, a data storage unit 423, a speaker unit 424, and a power supply unit 425. Here, CPU is an acronym of “Central Processing Unit”, ROM is an acronym of “Read Only Memory”, RAM is an acronym of “Random Access Memory”, and GPS is an acronym of “Global Positioning System”. The mobile terminal device 104 also includes a display unit 420 and an operation unit 418. The functional units in the main unit 411 are connected to each other by a system bus 628 managed by the CPU 412. Additionally, the main unit 411 and the WLAN unit 429 (the aforementioned WLAN unit 401) are connected, for example, by a dedicated bus 426.

The CPU 412 is a system control unit including at least one processor, and controls the mobile terminal device 104 as a whole. The processing by the mobile terminal device 104 described below is implemented by the CPU 412 executing programs stored in the ROM 413, for example. Note that dedicated hardware for each process may be provided. The ROM 413 stores control programs executed by the CPU 412, embedded operating system (OS) programs, and the like. In the present embodiment, the CPU 412 performs software control such as scheduling, task switching, and the like by executing each control program stored in the ROM 413 under the management of an embedded OS, which is also stored in the ROM 413.

The RAM 414 is constituted by a Static RAM (SRAM) or the like. The RAM 414 stores data such as program control variables, data such as setting values registered by the user and management data of the mobile terminal device 104, and the like. In addition, the RAM 414 can be used as various types of working buffers. The image memory 415 is constituted by a memory such as a dynamic RAM (DRAM) or the like. The image memory 415 temporarily stores image data received through the WLAN unit 429, image data read out from the data storage unit 423, and the like for processing by the CPU 412. The non-volatile memory 422 is constituted by a memory such as a flash memory, for example, and continues to store data even when the mobile terminal device 104 is turned off. Note that the memory configuration of the mobile terminal device 104 is not limited to the configuration described above. For example, the image memory 415 and the RAM 414 may be implemented by the same memory, data may be backed up like using the data storage unit 423, or the like. Additionally, although the present embodiment describes a DRAM as an example of the image memory 415, another storage medium such as a hard disk, a non-volatile memory, or the like may be used instead.

The data conversion unit 416 analyzes data in various formats, performs data conversion such as color conversion and image conversion, and the like. The telephone unit 417 controls a telephone line, and implements telephone communication by processing audio data input and output through the speaker unit 424. The GPS 419 receives radio waves transmitted from a satellite and obtains location information such as the current latitude, longitude, and the like of the mobile terminal device 104.

The camera unit 421 has a function for electronically recording and encoding an image input through a lens. The image data captured by the camera unit 421 is stored in the data storage unit 423. The speaker unit 424 performs control for implementing a function for inputting or outputting audio for the telephone function, other functions such as alarm notifications, and the like. The power supply unit 425 is a portable battery, for example, and control the supply of power to the interior of the device. Power states include, for example, a “battery depleted state” in which there is no power remaining in the battery, a “power off state” in which the power key 404 has not been pressed, an “operating state” in which the battery is running normally, and a “power-saving state” in which the battery is operating but is in a power saving state.

The display unit 420 is the display unit 402 described with reference to FIG. 4A, and displays various types of input operations, the operating state and status of the MFP 100, and the like under the control of the CPU 412. The operation unit 418 is the operation unit 403 described with reference to FIG. 4A, and when a user operation is accepted, performs control such as generating an electrical signal corresponding to the operation, outputting the electrical signal to the CPU 412, and the like.

The mobile terminal device 104 performs wireless communication using the WLAN unit 429, and performs data communication with other devices such as the MFP 100. The WLAN unit 429 converts data into packets and sends the packets to other devices. The WLAN unit 429 also restores packets from other external devices into the original data and outputs the data to the CPU 412. The WLAN unit 429 is a unit for implementing communication compliant with each WLAN standard. The WLAN unit 429 can operate in at least two communication modes simultaneously, including wireless infrastructure mode and P2P (WLAN) mode. Note that the frequency bands used in these communication modes can be limited by the functions and performance of the hardware.

### Configuration of Access Point

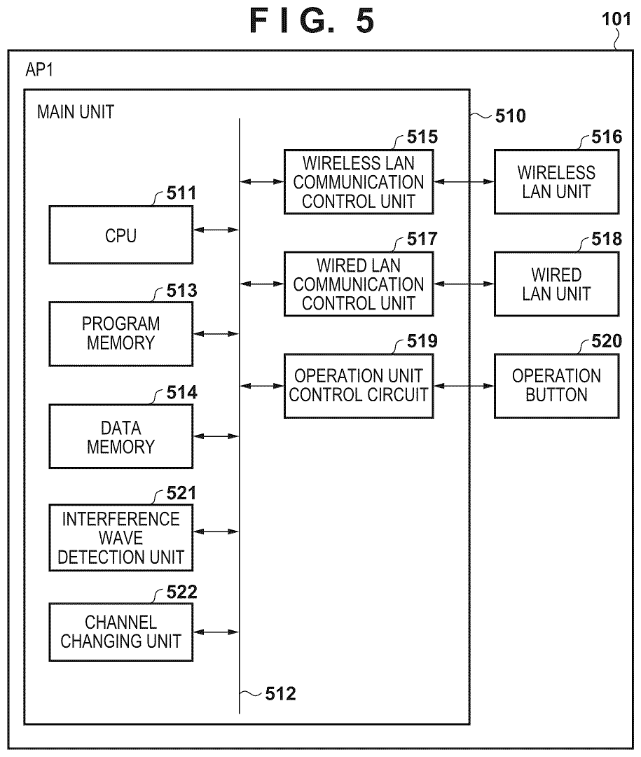

FIG. 5 is a block diagram illustrating the configuration of the AP101 having a wireless LAN access point function. A main unit 510, which controls the AP101, is configured including a wireless LAN unit 516, a wired LAN unit 518, and an operation button 520. The main unit 510 merely indicates a block which includes functional blocks other than the wireless LAN unit 516, the wired LAN unit 518, and the operation button 520.

A microprocessor-type CPU 511 disposed on the main unit 510 operates in accordance with a control program stored in a ROM-type program memory 513 and data in a RAM-type data memory 514, which are connected to the CPU 511 by an internal bus 512. The CPU 511 communicates with other communication terminal devices over a wireless LAN by controlling the wireless LAN unit 516 through a wireless LAN communication control unit 515. The CPU 511 also communicates with other communication terminal devices over a wired LAN by controlling the wired LAN unit 518 through a wired LAN communication control unit 517. The CPU 511 is capable of accepting operations made by a user manipulating the operation button 520, by controlling an operation unit control circuit 519. The CPU 511 includes at least one processor.

The AP101 also includes an interference wave detection unit 521 and a channel changing unit 522. The interference wave detection unit 521 performs interference wave detection processing when communicating wirelessly in a band in which dynamic frequency selection (DFS) is implemented. When communicating wirelessly in a band in which DFS is implemented, the channel changing unit 522 performs processing for changing the channel used when interference waves are detected, when it is necessary to immediately change to a free channel, and the like.

Note that the AP102 has the same configuration as the AP101.

### P2P Communication Method

An overview of a P2P (WLAN) communication method for devices to wirelessly communicate directly with each other without traversing an external access point in WLAN communication will be given next. P2P (WLAN) communication can be implemented through a plurality of methods, e.g., the communication device can support a plurality of modes for P2P (WLAN) communication and selectively execute P2P communication (WLAN) using one of the plurality of modes.

The following two modes are assumed as P2P modes.
Software AP Mode
Wi-Fi Direct (WFD) Mode

A communication device capable of P2P communication can be configured to support at least one of these modes. However, even a communication device capable of P2P communication does not have to support all of these modes, and may be configured to support only some.

In a communication device having a WFD communication function (e.g., the mobile terminal device 104), an application for implementing the communication function (in some cases, a dedicated application) is called in response to a user operation being accepted through the operation unit of the device. The communication device can then display a screen of a user interface (UI) provided by the application to prompt the user to perform an operation, and then perform WFD communication based on the user operation accepted in response thereto.

### Software AP Mode

In the software AP mode, the communication device (e.g., the mobile terminal device 104) operates in the role of a client requesting various types of services. The other communication device (e.g., the MFP 100) operates as a software AP capable of performing WLAN AP functions through software settings. Note that commands, parameters, and the like sent and received when establishing a wireless connection between the client and the software AP may be any specified by the Wi-Fi (registered trademark) standard, and will therefore not be described. The MFP 100 operating in software AP mode also determines a frequency band and a frequency channel as a primary station. Accordingly, the MFP 100 can select which frequency band to use from 5 GHz and 2.4 GHz, as well as which frequency channel to use in that frequency band.

### WFD Mode

The MFP 100 may be started so as to be fixed as the primary station for the WFD mode (Autonomous Group Owner). In this case, GO Negotiation processing for determining the role is unnecessary. Furthermore, in this case, the MFP 100 also determines the frequency band and the frequency channel to be used as the primary station. Accordingly, the MFP 100 can select which frequency band to use from 5 GHz and 2.4 GHz, as well as which frequency channel to use in that frequency band.

### Wireless Infrastructure Mode

In wireless infrastructure mode, communication devices that communicate with each other (e.g., the mobile terminal device 104 and the MFP 100) are connected to an external AP that manages the network (e.g., the AP101), and the communication devices communicate with each other through the AP. In other words, communication between the communication devices is executed over a network constructed by an external AP. The mobile terminal device 104 and the MFP 100 each discover the AP101, and by sending a connection request and connecting to the AP101, those communication devices can communicate in wireless infrastructure mode via the AP101. Note that a plurality of communication devices may be connected to individual separate APs. In this case, the communication devices can communicate by data being transferred among the APs. The commands, parameters, and the like sent and received during communication between the communication devices via the access points may be any specified by the Wi-Fi standard, and will therefore not be described. In this case, the AP101 also determines the frequency band and the frequency channel. Accordingly, the AP101 can select which frequency band to use from 5 GHz or 2.4 GHz and 6 GHz, as well as which frequency channel to use in that frequency band.

Processing in Response to Request to Change Connection Destination from AP to STA

The mobile terminal device 104 and the MFP 100 correspond support functions disclosed as Wi-Fi Agile Multiband (registered trademark). Wi-Fi Agile Multiband is a function that enables the selection of an optimal environment in response to changing conditions of a Wi-Fi network. To be more specific, an STA such as the mobile terminal device 104 and the MFP 100, and an AP such as the AP101, exchange information about the network environment using an IEEE 802.11 series communication standard. By exchanging information in this manner, when the network is congested, the AP can guide the STA (change the connection destination) to another AP, a frequency band, a channel, or even another cellular service.

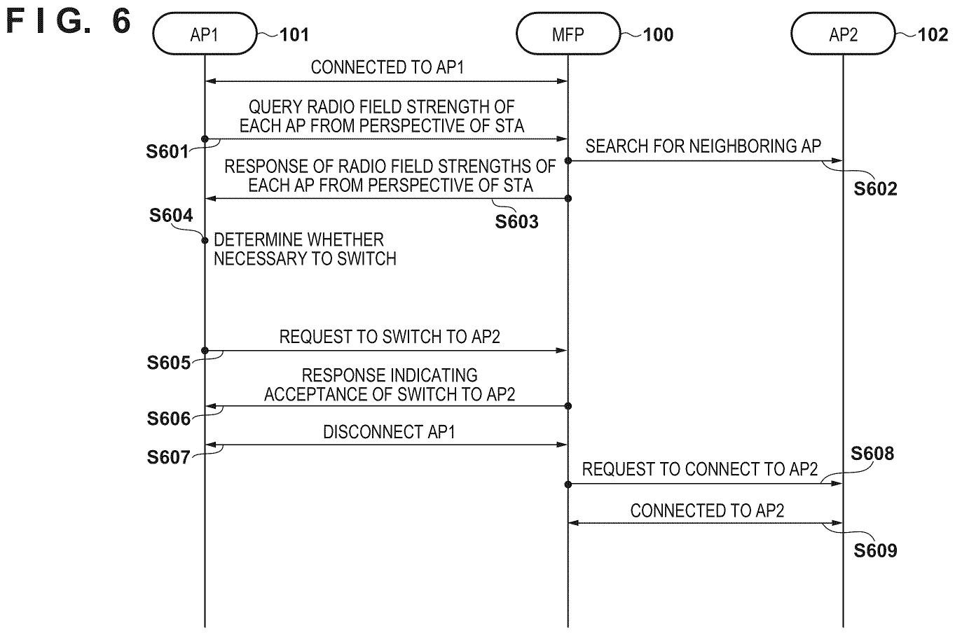

FIG. 6 is a sequence chart illustrating a case where the MFP 100 switches the connection destination AP from the AP101 to the AP102 in response to a connection destination change request (a change request of an access point serving as a connection destination) from the AP 101. Processing executed by each device in this sequence is implemented by the CPU of each device reading out various programs stored in a memory provided in that device, such as a ROM or the like, into a RAM and executing those programs.

In the initial state of the processing illustrated in FIG. 6, it is assumed that the MFP 100 has established a connection with the AP101 in wireless infrastructure mode. When the MFP 100 and the AP101 connect in wireless infrastructure mode, the AP101 obtains information as to whether the MFP 100 supports IEEE 802.11v. It is assumed that the following processing is then performed when the AP101 has successfully obtained information indicating that the MFP 100 supports IEEE 802.11v.

In step S601, the AP101 sends a query (a measurement request) to the MFP 100 regarding the radio wave strength of the APs around the MFP 100. This query is sent, for example, as a beacon frame request or a beacon report request. In other words, a mechanism defined in the IEEE 802.11k standard can be used for this request.

In step S602, in response to the request received in step S601, the MFP 100 receives frames transmitted by the surrounding APs and measures the radio wave strengths thereof. As a result, the radio wave strength of each of the plurality of APs, including the AP101 and the AP102, is measured.

In step S603, the MFP 100 sends a list of the radio wave strengths of the APs around the MFP 100, measured in step S602, as a response to the request received in step S601. The radio wave strengths provided in the response may be information saved in the RAM 214, the non-volatile memory 215, and the like of the MFP 100, in addition to or instead of the information measured in step S602. This response is sent, for example, as a beacon report or a measurement report.

In step S604, the AP101 determines whether it is necessary to switch the connection destination of the MFP 100 based on the congestion state in the network, which the AP101 has ascertained, and the radio wave strengths received from the MFP 100 in step S603. The AP101 determines that it is necessary to switch the connection based on factors such as there being a large number of connected STAs, a high communication volume, other APs experiencing less congested, the presence or absence of mixed radio waves, AP functions being suspended, and the like. When it is determined that it is necessary to switch the connection destination of the MFP 100, and the Service Set Identifier (“SSID” hereinafter), the channel, and the frequency band of the other AP designated to be switched to by the MFP 100 are determined, the sequence moves to step S605.

In step S605, the AP101 sends an AP change request (a connection destination switching request) to the MFP 100. The connection destination change request includes the SSID, channel, and frequency band information of the other AP designated to be switched to by the MFP 100, determined in step S604. Note that a plurality of SSIDs may be designated. The connection destination change request is sent as a BTM request, for example. In other words, a BSS Transition Management (BTM) Request frame, defined in the IEEE 802.11v standard, is sent. The example illustrated in FIG. 6 assumes that the AP102 is designated as the switch destination included in the connection destination change request.

In step S606, if the connection destination change request received in step S605 is to be complied with, the MFP 100 sends a response indicating approval of the switch to the AP101. If the connection destination change request is not to be complied with, a switch rejection may be sent as a response. The response is sent as a BTM response. The example in FIG. 6 assumes that a response indicating approval is sent.

In step S607, the AP101 and the MFP 100 terminate the connection in wireless infrastructure mode.

In step S608, the MFP 100 sends a connection request to the AP102 so as to connect to the AP102 designated in the connection destination change request received in step S605.

As a result, in step S609, a connection between the MFP 100 and the AP102 is established in wireless infrastructure mode.

Using such a mechanism, the MFP 100, which is the STA, can change the connection destination from the AP101 to the AP102 based on the connection destination change request from the AP101 to which the MFP 100 was originally connected. The AP101 and the AP102 may be APs installed in different locations. In other words, through the processing illustrated in FIG. 6, the MFP 100 can switch to another AP installed in a location different from the AP to which the MFP 100 was originally connected. There are also situations where the AP handles mutually-different frequency bands among a plurality of frequency bands provided by the same device (two or three of the 2.4 GHz band, the 5 GHz band, and the 6 GHz band). In other words, through the processing illustrated in FIG. 6, the MFP 100 can switch to another frequency band provided by the same device as the AP to which the MFP 100 was originally connected. For example, the connection destination can be changed to an AP in the 6 GHz band based on the connection destination change request.

Although the present embodiment describes an example in which the measurement request and a connection destination change request from the AP are sent using a mechanism compliant with Wi-Fi Agile Multiband, and the STA responds thereto, the configuration is not limited thereto. The present embodiment can be applied even if the STA makes a response, changes the connection destination AP (switches, deletes, or adds an AP to serve as a connection destination), or the like in response to a measurement request or a connection destination change request sent from the AP using a different mechanism from that in the example described above.

There are situations where changing the connection destination AP based on a change request for changing the connection destination AP sent from the AP currently connected poses no problems, and situations where doing so is not desirable. In situations where changing the connection destination AP based on a change request is not desirable, one or more of the following types of processing can be combined as processing for suppressing a change in the connection destination in response to the change request. The following processing is processing that prevents or makes it difficult to change the connection destination AP based on a change request.

(Suppression Processing 1) Even if the change request described in step S605 is received, the connection destination AP is not changed based on the received connection request, and the change request is not responded to, or a response indicating that the change request has been rejected (that the connection destination AP will not be changed) is sent to the AP currently connected. When a rejection response is sent, the priority of the connection destination change for another STA connected to the AP currently connected to the MFP 100 is raised and the priority of the connection destination change for the MFP 100 that returned the rejection response is lowered. As a result, the connection with the AP that has been connected can be maintained. If no response is returned (that is, the request is ignored), it is thought that the AP currently connected will maintain the connection with the MFP 100 to wait for a response until a timeout following a response standby time. Accordingly, in a situation where the connection is terminated immediately in accordance with some response to a change request from the MFP 100, the connection with the AP currently connected longer by not responding rather than returning some kind of response. Accordingly, for example, based on information indicating the reason for the change included in the change request, the processing can be varied according to the reason, such as rejecting the request if the reason is weak or ignoring the request if the reason is strong. The reason for the change can be determined based on, for example, information included in Request Mode in the BTM Request, indicating which of several reasons is applicable. For example, if the Disassociation Imminent bit or the BSS Termination Included bit of Request Mode is 1, the change request can be determined to be a request in which the reason for the change is strong. Otherwise, the change request can be determined to be a request in which the reason for the change is weak.

(Suppression Processing 2) In response to the measurement request described in step S601, information indicating that the radio wave reception conditions (signal reception conditions) of an unconnected AP other than the AP currently connected are worse than the actual measured conditions situation (poor signal quality) is provided as a response (a false response). In this case, the response may be made after taking an actual measurement in response to the reception of the measurement request, or the response may be made without actually taking a measurement. Specifically, in the response described with reference to step S603 (a beacon report or the like), a value indicating a lower received signal strength and/or a value indicating higher noise (signal-to-noise ratio) is provided to as a response to the signal quality measured for the signal received from the unconnected AP. Alternatively, the response may be a response that does not include at least one piece of information on the unconnected AP. Processing may also be performed in which the response is provided having set the received signal strength to an extremely low value or having set the noise to an extremely high value, based on information measured for the unconnected AP in the past. Even if a measurement request is received, a response indicating a good received signal strength or noise conditions only for the AP currently connected may be provided, without taking an actual measurement (AP search) and without including the information on the unconnected AP. Responding to the measurement request without including the information on the unconnected AP in the response corresponds to content indicating that no other unconnected AP has been found even after performing an AP search. In other words, not including the information on the unconnected AP in the response indicates that the signal quality from the unconnected AP is at least partially worse than when the AP search was actually performed.

By doing so, connection destination change requests being sent from the AP currently connected to other APs can be expected to be suppressed. A change in the connection destination in response to the connection destination change request is therefore suppressed.

(Suppression Processing 3) The AP currently connected is temporarily disconnected, information indicating that the change request is not supported is provided, and the same AP is then reconnected. Specifically, the wireless connection with the AP currently connected is temporarily terminated, and data of the Association Request frame, including information indicating that IEEE 802.11v is not supported, is generated as a preparation for reestablishing the wireless connection. Processing for connecting to the AP is then performed using the generated Association Request frame data. As a result, if an Association Request frame including information indicating that IEEE 802.11v is not supported is generated, the AP is connected to as an electronic apparatus that does not support the functions of the Agile Multiband. As a result, the AP currently connected recognizes that the MFP 100 does not support IEEE 802.11v, and does not send a wireless connection destination change request to the MFP 100. As a result, the request to change the wireless connection is no longer made to the MFP 100, and thus the wireless connection between the MFP 100 and the AP currently connected is easier to maintain. In addition, if the AP currently connected recognizes that the MFP 100 does not support IEEE 802.11v, the transmission of the measurement request (the request described with reference to step S601) from the AP currently connected to the MFP 100 is also stopped. Accordingly, the measurement in response to the measurement request (the AP search) and the response to the measurement request (the processing of step S603) can also be suppressed in the MFP 100. The processing load and power consumption can be reduced by that amount, and the resources can be allocated to other processing.

For example, printing data being received corresponds to a state where it is not desirable to change the connection destination AP based on a change request. The MFP 100 receiving printing data corresponds to a state where some of the printing data of an image to be printed has already been received by the mobile terminal device 104, which is the partner device, but the remainder of the printing data has not yet been received. The MFP 100 does not store all of the printing data to be printed on a single sheet of paper. Accordingly, the MFP 100 prints by repeating an operation in which some of the printing data is received and then printed (e.g., one line's worth of printing data is received in printed), after which the next data is received and then printed. If the connection destination AP is changed based on a connection destination change request while the printing data is being received, the processing for switching the connection destination will produce time lag, which may lead to a drop in the print quality, such as by producing unevenness in the printing. Additionally, the quality of communication with the mobile terminal device 104, which is the partner device, may drop after the connection destination is switched, making it impossible to receive the subsequent data and resulting in a printing failure. It is therefore preferable to perform at least one of the above-described processing (Suppression Processing 1 and Suppression Processing 2) as processing for suppressing a change in the connection destination in response to a change request while printing data is being received, or to perform the above-described processing (Suppression Processing 3) before starting to receive printing data.

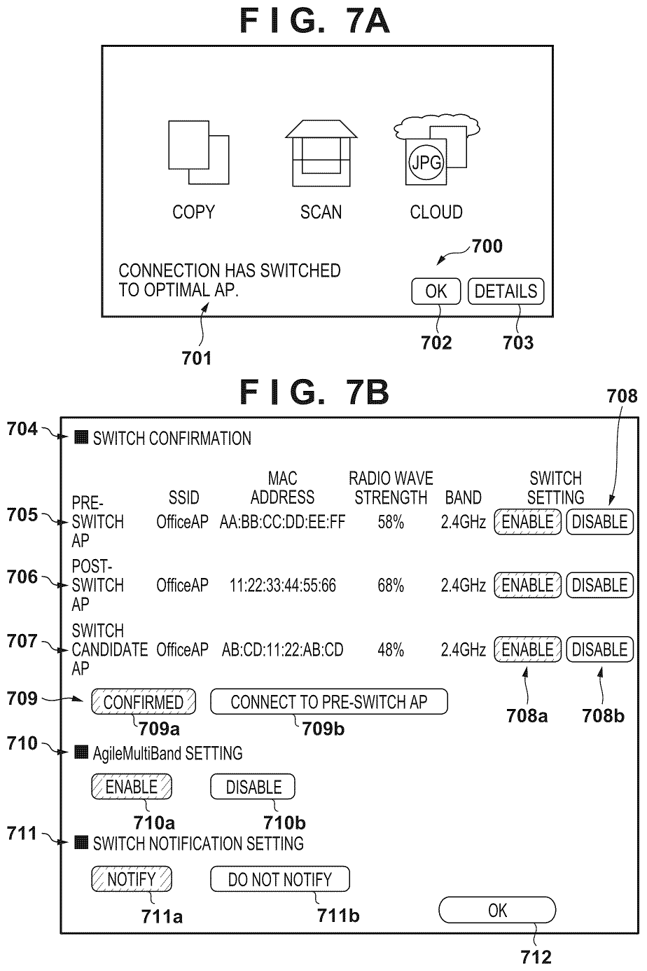

Screen Display When Connection Destination AP Has Switched FIGS. 7A and 7B schematically illustrate examples of screens displayed in the console unit 220 of the MFP 100 when the connection destination AP of the MFP 100 has been switched. FIG. 7A is a diagram illustrating an example of a status notification displayed in the home screen illustrated in FIG. 3A, in response to the connection destination AP of the MFP 100 having switched.

A status notification display part 700 is displayed in the home screen illustrated in FIG. 7A in response to the connection destination AP of the MFP 100 having switched. A status notification 701, an OK button 702, a details button 703, and the like are displayed in the status notification display part 700. Although the present embodiment describes an example in which the status notification display part 700 is displayed at the bottom of the home screen, the configuration is not limited thereto. For example, the status notification display part 700 may be displayed at the top of the home screen, in the center, or the like.

The status notification 701 is a notification indicating that the connection destination AP of the MFP 100 has switched. The status notification 701 makes it possible for the user to recognize that the connection destination AP of the MFP 100 has switched.

Additionally, a message indicating that the connection destination has been changed to an AP having a better communication environment than the AP that was originally connected is displayed in the status notification 701. In this example, the status notification 701 displays a message indicating that the connection has been switched to an optimal AP, but the message communicated by the status notification 701 is not limited thereto. For example, the status notification 701 may display a message indicating that the connection has switched to an AP having better radio wave conditions, a message indicating that the connection has switched to an AP having a more stable connection with the MFP 100, or the like. Displaying the status notification 701 in this manner makes it possible for the user to recognize that the connection has been changed to a more beneficial AP.

The OK button 702 is an interface for accepting an instruction to stop the display of the status notification display part 700. For example, when the user confirms the status notification 701 and presses the OK button 702, the MFP 100 accepts the stop of the display of the status notification display part 700, and controls the display in the console unit 220 to return to the home screen illustrated in FIG. 3A. In other words, when the user presses the OK button 702, the MFP 100 performs display control for hiding the status notification display part 700.

The details button 703 is an interface for accepting an instruction to switch to a detailed notification screen. For example, when the details button 703 is pressed by the user, the MFP 100 accepts an instruction to switch to the detailed notification screen, and performs display control for displaying the detailed notification screen, illustrated in FIG. 7B and described later, in the console unit 220.

In this manner, the MFP 100 accepts touch-based or key-based operations of the OK button 702, the details button 703, and the like displayed in the status notification illustrated in FIG. 7A, and controls the display in accordance with the operations. If a predetermined amount of time has passed following the display of the status notification display part 700, the MFP 100 stop the display of the status notification display part 700. For example, the MFP 100 stops the display of the status notification display part 700 if the OK button 702, the details button 703, or the like has not been operated by the user within a predetermined time after the status notification display part 700 is displayed. The MFP 100 may also update and display the status notification display part 700 when the connection is switched to yet another AP. Alternatively, if a connection destination change request is received from the AP currently connected while the status notification display part 700 is displayed in the home screen, the MFP 100 may perform control so as not to change the connection destination based on the connection change request. For example, if a connection destination change request is received from the AP currently connected while the status notification display part 700 is displayed in the home screen, the MFP 100 may perform control so as not to issue a response approving the switch. In other words, if a connection destination change request is received from the AP currently connected while the status notification display part 700 is displayed in the home screen, the MFP 100 may issue a response indicating that the connection destination change request has been rejected to the AP currently connected. Alternatively, the MFP 100 may perform control so as to ignore the connection destination change request.

FIG. 7B is a diagram illustrating an example of the detailed notification screen displayed in the console unit 220. The detailed notification screen is displayed in the console unit 220 when, for example, the details button 703 is pressed by the user in the home screen illustrated in FIG. 7A. As will be described later, the detailed notification screen is a screen for displaying information such as the communication environment, identification information, and the like of the pre-switch AP and the post-switch AP, making settings pertaining to the switch, and the like. A switch confirmation part 704, an Agile Multiband setting part 710, a switch notification setting part 711, an OK button 712, and the like are displayed in the detailed notification screen.

The switch confirmation part 704 is an item for displaying detailed information, settings, and the like pertaining to the pre- and post-switch APs, AP switch candidates, and the like. Pre-switch AP information 705, post-switch AP information 706, switch candidate AP information 707, switch settings 708, a confirmed button 709a, a connect button 709b for connecting to the pre-switch AP, and the like are displayed in the switch confirmation part 704.

Information corresponding to the pre- and post-switch APs, switch candidate APs, and the like is displayed in the AP information 705 to 707. The information corresponding to the pre- and post-switch APs and switch candidate APs is, for example, identification information such as an SSID or a Media Access Control address (“MAC address” hereinafter), information pertaining to the communication environment, and the like. The switch candidate APs are APs that may be switched to through Agile Multiband. For example, a plurality of switch destination APs may be included in a connection destination change request received from the AP101 by the MFP 100. The MFP 100 may determine the AP to be switched to from among the plurality of switch destination APs based on, for example, information such as the radio wave strength, the frequency band, the radio wave congestion conditions, and the like. The MFP 100 may take APs aside from the AP to be switched to as switch candidate APs.

The information pertaining to the communication environment is information indicating the radio wave strength as seen from the MFP 100, information indicating the corresponding frequency band of the AP, or the like. The information pertaining to the communication environment may also be information indicating a communication band, information indicating radio wave congestion conditions in the communication channel (not shown), or the like. In this manner, information pertaining to the communication environment of the respective APs is displayed as the pre-switch AP information 705 and the post-switch AP information 706, which makes it possible for the user to confirm in detail whether the MFP 100 has switched to a more beneficial AP.

The information indicating the radio wave strength may be displayed after, for example, the MFP 100 measures the radio wave strength of the pre-switch AP, the post-switch AP, and the switch candidate APs. For example, the MFP 100 may measure the radio wave strength of each AP through processing similar to that described with reference to step S601 when MFP 100 has switched the connection destination AP, when the details button 703 or the like has been pressed by the user, or the like. The corresponding frequency band of the AP may be obtained by the MFP 100 measuring the radio wave strength of each AP.

The switch settings 708 are setting items which enable Agile Multiband switch settings to be enabled or disabled for the pre- and post-switch APs, the switch candidate APs, and the like. An interface capable of accepting an instruction to enable switch settings for each AP (an enable button 708a) and an interface capable of accepting an instruction to disable switch settings for each AP (a disable button 708b) are displayed in the switch settings 708. This makes it possible for the user to make switch settings individually for the pre- and post-switch APs, the switch candidate APs, and the like. For example, the user can set an AP that is not to be switched to be disabled among the pre- and post-switch APs, the switch candidate APs, and the like.

The confirmed button 709a is an interface capable of accepting an instruction indicating that the AP information 705 to 707 has been confirmed by the user. The connect button 709b for connecting to the pre-switch AP is an interface capable of accepting an instruction to change the connection destination AP of the MFP 100 from a connection to the post-switch AP to the pre-switch AP. In other words, the connect button 709b for connecting to the pre-switch AP is an interface capable of accepting an instruction to return the connection destination AP of the MFP 100 to the pre-switch AP. The MFP 100 may store identification information such as an SSID, a MAC address, or the like of the AP to which a connection has been made in the past in a memory such as the ROM 213 or the non-volatile memory 215, for example. If the MFP 100 accepts the pressing of the connect button 709b for connecting to the pre-switch AP by the user, the MFP 100 terminates the connection with the post-switch AP through processing that will be described later. The MFP 100 reads out the identification information of the pre-switch AP stored in the memory, and performs control so as to connect to the pre-switch AP. In this manner, the interface 709b capable of accepting an instruction to reconnect to the pre-switch AP is displayed, which makes it possible, for example, to change the connection destination of the MFP 100 to the original AP, even if the connection destination AP of the MFP 100 has been switched to an AP not intended by the user.

The Agile Multiband setting part 710 is a setting item for enabling or disabling Agile Multiband. An interface capable of accepting an instruction to enable Agile Multiband (an enable button 710a) and an interface capable of accepting an instruction to disable Agile Multiband (a disable button 710b) are displayed in the Agile Multiband setting part 710. In other words, these interfaces 710a and 710b are interfaces capable of accepting instructions as to whether to perform a function for switching from an access point currently connected to another access point. For example, the MFP 100 disables Agile Multiband when the user presses the disable button 710b. In other words, even if a connection destination change request is received from the AP currently connected, the MFP 100 does not issue a response approving the switch. For example, the power consumption of the MFP 100 can be suppressed by disabling Agile Multiband.

The switch notification setting part 711 is a setting item for setting whether to make a status notification in response to the connection destination AP of the MFP 100 having been switched. An interface capable of accepting an instruction to make a status notification when the AP is switched (a notify button 711a) and an interface capable of accepting an instruction not to notify (a do not notify button 711b) are displayed in the switch notification setting part 711. For example, if the do not notify button 711b is pressed by the user, the MFP 100 performs control so as not to make the status notification, even if the connection destination AP is switched.

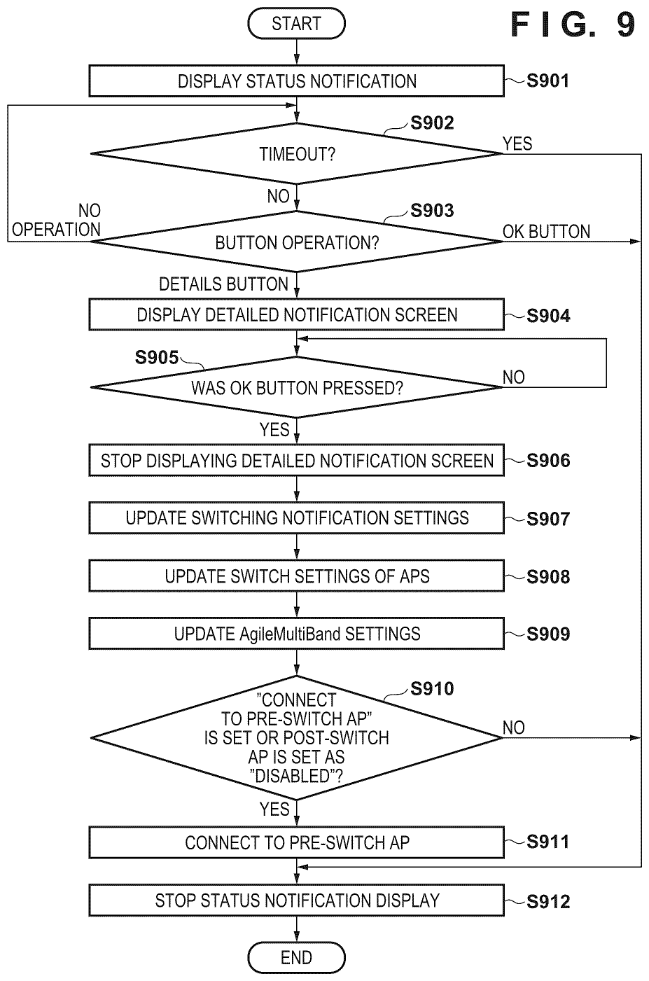

The settings for the setting items 708 to 711 that have been accepted as a result of the user pressing the interface items in FIG. 7B are applied when the OK button 712 is pressed. As a result, the MFP 100 can operate in accordance with the settings. The processing performed by the MFP 100 when the OK button 712 is pressed by the user will be described with reference to FIG. 9.

Although the present embodiment describes an example in which the interfaces for the setting items 704 to 711 are displayed in the detailed notification screen in button format, the configuration is not limited thereto. For example, the display may be made in a selection-based format, such as using radio boxes, or may be implemented by another format such as displaying through direct input.

Additionally, although the home screen illustrated in FIG. 7A and the detailed notification screen illustrated in FIG. 7B described thus far have been indicated as being displayed in the console unit 220 of the MFP 100, the configuration is not limited thereto. For example, the MFP 100 may use Hypertext Transfer Protocol (HTTP) communication or the like through a remote UI function or the like to display the screens illustrated in FIGS. 7A and 7B in a display unit of an external device such as the mobile terminal device 104. For example, even if the MFP 100 does not include the console unit 220, the user can recognize that the connection destination AP of the MFP 100 has been switched by displaying the screens illustrated in FIGS. 7A and 7B in the display unit of the external device in this manner. This also enables the user to make the switch settings described above.

Furthermore, although the present embodiment describes an example in which the status notification 701 is displayed in the console unit 220 of the MFP 100, the configuration is not limited thereto. For example, the status notification 701 may be communicated by audio using a speaker unit (not shown) of the MFP 100, the speaker unit 424 of the mobile terminal device 104, or the like. This makes it possible for the user to recognize that the connection destination AP of the MFP 100 has been switched, even if the user is not looking at the MFP 100. Additionally, for example, the status notification 701 may be communicated by printing a report using the printing unit 222 of the MFP 100. Additionally, the pre- and post-switch AP information and the like of the access points in the detailed notification screen illustrated in FIG. 7B may be printed as a report using the printing unit 222 of the MFP 100. The user can recognize that the connection destination AP of the MFP 100 has been switched even when using such formats.

### AP Switching Processing by MFP 100

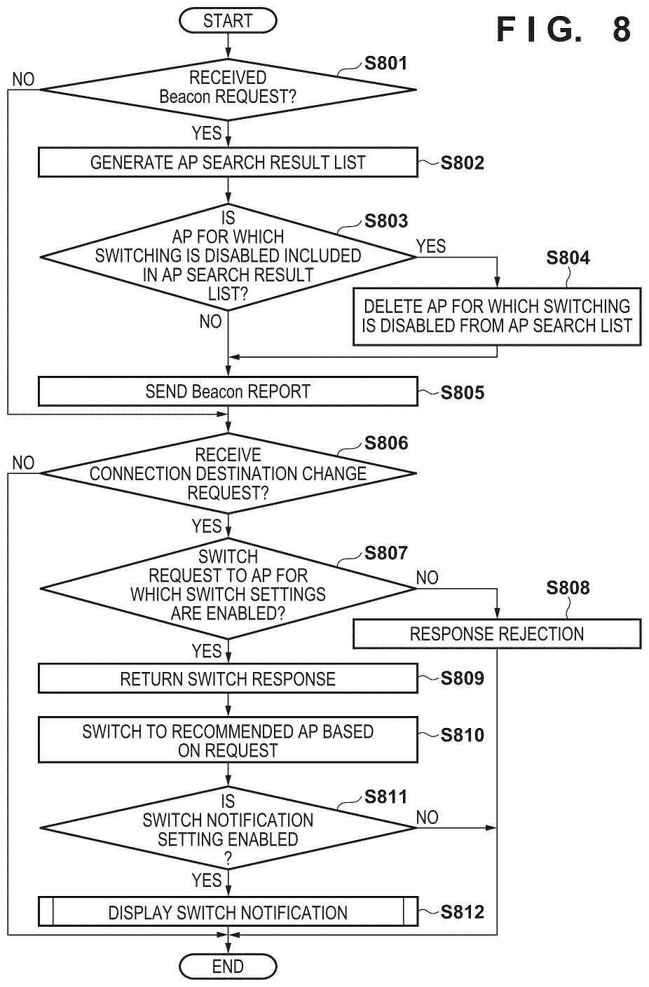

An example of processing performed by the MFP 100 will be described next with reference to the flowchart in FIG. 8. In this flowchart, the processing performed by the MFP 100 is implemented by the CPU 212 reading out various programs stored in a memory such as the ROM 213 into the RAM 214 and executing those programs.

In the initial state of the processing illustrated in FIG. 8, it is assumed that the MFP 100 has established a connection with the AP101 in wireless infrastructure mode. When the MFP 100 and the AP101 connect in wireless infrastructure mode, the AP101 obtains information as to whether the MFP 100 supports IEEE802.11v. It is assumed here that the AP101 has obtained information indicating that the MFP 100 supports IEEE802.11v, queries the MFP 100 for the radio wave strength, and issues a connection destination AP change request.

In step S801, the CPU 212 determines whether a query (a measurement request) for the radio wave strength of the APs around the MFP 100 has been received from the AP101. This query is sent as a beacon frame request, a beacon report request, or the like. The query for the radio wave strength received and confirmed in this step corresponds to that sent by the AP101 in step S601 of FIG. 6. If the CPU 212 determines that a radio wave strength query has been received (YES in step S801), the sequence moves to step S802. However, if the CPU 212 determines that a radio wave strength query has not been received (NO in step S801), the sequence moves to step S806.

In step S802, the CPU 212 generates an AP search result list. Specifically, as described with reference to step S602 of FIG. 6, the CPU 212 searches out the APs around the MFP 100 by measuring the radio wave strengths of the APs around the MFP 100, and generates a list of the radio wave strengths of the APs. In other words, the AP search result list is a list of the radio wave strengths of the APs.

In step S803, the CPU 212 determines whether an AP for which switching is disabled is present in the AP search result list. If the CPU 212 determines that an AP for which switching is disabled is present in the AP search result list (YES in step S803), the sequence moves to step S804. However, if the CPU 212 determines that an AP for which switching is disabled is not present in the AP search result list (NO in step S803), the sequence moves to step S805. Specifically, the CPU 212 refers to the list of radio wave strengths of the APs generated in step S802, and determines whether there is an AP for which the switch settings are disabled. For example, based on the disable button 708b having been pressed by the user in the detailed notification screen illustrated in FIG. 7B, the AP corresponding to the disable button 708b may be stored in a memory such as the ROM 213 or the non-volatile memory 215 as an AP for which switching is disabled. The CPU 212 may read out the information on the APs for which the switch settings stored in the memory are disabled, and then make the determination described above.

In step S804, the CPU 212 deletes the AP for which switching is disabled from the AP search result list. Specifically, the CPU 212 deletes the AP for which the switch settings determined in step S803 are disabled from the list of radio wave strengths generated in step S802.

In step S805, the CPU 212 sends the AP search result list generated in step S802, or the AP search result list from which the AP for which switching is disabled was deleted in step S804, to the AP101 as a beacon report.

In step S806, the CPU 212 determines whether a connection destination AP change request sent from the AP101 has been received. This change request corresponds to that sent by the AP101 in step S605 of FIG. 6. If the CPU 212 determines that the change request has been received (YES in step S806), the sequence moves to step S807. However, if the CPU 212 determines that the change request has not been received (NO in step S806), the sequence of FIG. 8 ends.

In step S807, the CPU 212 determines whether the switch destination AP included in the received connection destination AP change request is an AP for which the switch settings are enabled. If the CPU 212 determines that the AP is an AP for which the switch settings are enabled (YES in step S807), the sequence moves to step S809. However, if the CPU 212 determines that the AP is not an AP for which the switch is enabled (NO in step S806), the sequence moves to step S808. For example, if the enable button 708a has been pressed by the user in the detailed notification screen illustrated in FIG. 7B, the CPU 212 may store the AP corresponding to the enable button 708a in a memory such as the ROM 213 or the non-volatile memory 215 as an AP for which switching is enabled. For example, the CPU 212 may read out the information of the AP for which the switch settings are enabled from the memory, and determine whether the switch destination AP included in the connection destination AP change request is an AP for which the switch settings are enabled.

In step S808, the CPU 212 performs control such that the connection is not changed in response to the change request. Specifically, the CPU 212 sends a response indicating that the change has been rejected to the AP101 in response to the change request, after which the sequence moves to step S911. This process corresponds to sending the rejection response in step S606 of FIG. 6, and corresponds to the Suppression Processing 1 described above. Note that in step S808, the CPU 212 may perform control so as not to respond to the change request. In other words, the CPU 212 may perform control so as to ignore the change request.

In step S809, the CPU 212 sends, to the AP101, a response indicating that the connection destination change request received from the AP101 is to be complied with. Step S809 corresponds to the processing performed in step S606 of FIG. 6.

In step S810, the CPU 212 terminates the connection with the AP101, and performs processing for connecting to the connection destination AP included in the connection destination change request. Step S810 corresponds to the processing performed in step S607, step S608, and step S609.

In step S811, the CPU 212 determines whether a switch notification setting is enabled. If the CPU 212 determines that the switch notification setting is enabled (YES in step S811), the sequence moves to step S812. However, if the CPU 212 determines that the switch notification setting is not enabled (NO in step S811), the sequence in FIG. 8 ends. For example, the CPU 212 may store information pertaining to the switch notification setting. For example, the CPU 212 may store a setting indicating that the switch notification is enabled in a memory such as the ROM 213, the non-volatile memory 215, or the like in response to the notify button 711a being pressed by the user in the detailed notification screen illustrated in FIG. 7B. The CPU 212 may read out the information on the switch notification setting stored in the memory, and then make the determination described above. Meanwhile, if the do not notify button 711b has been pressed by the user in the detailed notification screen illustrated in FIG. 7B, the CPU 212 determines that the switch notification setting is not enabled.

In step S812, the CPU 212 performs processing for displaying the switch notification. The processing for displaying the switch notification will be described in detail later with reference to FIG. 9. The CPU 212 ends the sequence in FIG. 8 after performing the processing for displaying the switch notification.

### AP Switch Notification

The flowchart in FIG. 9 illustrates an example of the switch notification processing executed by the MFP 100 (step S812). In this flowchart, the processing performed by the MFP 100 is implemented by the CPU 212 reading out various programs stored in a memory such as the ROM 213 into the RAM 214 and executing those programs.

In step S901, the CPU 212 displays a status notification in the console unit 220. Specifically, the CPU 212 controls the status notification display part to be displayed in the home screen of the console unit 220 of the MFP 100. In other words, the CPU 212 displays the status notification 701, which is a notification indicating that the connection destination AP has switched, as well as the OK button 702 and the details button 703.

Although the present embodiment describes an example in which the status notification display part 700 is displayed in the home screen, the configuration is not limited thereto. For example, the CPU 212 may display the notification indicating that the connection destination AP has switched in the entire screen of the console unit 220 as a pop-up screen or the like.

Additionally, if the MFP 100 has transitioned to a power-saving state and the home screen is not displayed in the console unit 220, the CPU 212 may, in step S901, control the MFP 100 to transition to a power state in which the home screen can be displayed in the console unit 220. This makes it easier for the user to recognize that the connection destination AP of the MFP 100 has switched.

In step S902, the CPU 212 determines whether a predetermined length of time has passed after the status notification display part was displayed in the console unit 220 in step S901. The CPU 212 measures the time from when the status notification display part was displayed in the console unit 220 in the processing of step S901. If the CPU 212 determines that the predetermined length of time has passed (YES in step S902), the sequence moves to step S912. However, if the CPU 212 determines that the predetermined length of time has not passed (NO in step S902), the sequence moves to step S903.

In step S903, the CPU 212 determines a user operation on the console unit 220, made in the status notification display part 700 displayed in step S901. The CPU 212 monitors user operations of the console unit 220, and if the CPU 212 determines that the OK button 702 has been operated (“OK button” in step S903), the sequence moves to step S912. Or, if the CPU 212 determines that the details button 703 has been operated (“details button” in step S903), the sequence moves to step S904. Or, if the CPU 212 determines that no operation has been made (“no operation” in step S903), the sequence moves to step S902.

In step S904, the CPU 212 displays the detailed notification screen in the console unit 220. The CPU 212 displays the detailed notification screen illustrated in FIG. 7B in the console unit 220 in response to the user pressing the details button 703, for example. In other words, the CPU 212 may perform display control for switching the display screen from the home screen to the detailed notification screen, display control for displaying the detailed notification screen as a pop-up, or display control for displaying the detailed notification screen in the home screen.

In step S905, the CPU 212 determines a user operation on the console unit 220, made in the detailed notification screen displayed in step S904. Specifically, the CPU 212 monitors user operations in the console unit 220 in the processing of step S904. If the CPU 212 determines that the OK button 712 has been operated (YES in step S905), the sequence moves to step S906. Or, if the CPU 212 determines that the OK button 712 has not been operated (NO in step S905), step S905 is repeated.

In step S906, the CPU 212 performs display control for stopping the display of the detailed notification screen (FIG. 7B). In other words, the CPU 212 performs display control for hiding the detailed notification screen. Additionally, in the processing of step S906, the CPU 212 stores all user operations in the detailed notification screen in response to the OK button 712 in the detailed notification screen being operated. For example, the CPU 212 stores the instruction accepted through the operations of each button in the detailed notification screen.

In step S907, the CPU 212 updates the switch notification settings. Specifically, for example, if the notify button 711a has been pressed by the user in the detailed notification screen displayed in step S904, the CPU 212 stores the switch notification setting as being enabled in a memory such as the non-volatile memory 215, the RAM 214, or the like. However, if the do not notify button 711b has been pressed, the CPU 212 stores the switch notification as being disabled in a memory such as the non-volatile memory 215, the RAM 214, or the like.

In step S908, the CPU 212 updates the switch settings for each AP. Specifically, for example, if the enable button 708a has been pressed by the user in the detailed notification screen displayed in step S904, the CPU 212 stores the APs (706 to 708) corresponding to the enable button 708a as having switching enabled in a memory such as the non-volatile memory 215, the RAM 214, or the like. However, if the disable button 708b has been pressed by the user, the CPU 212 stores the APs (705 to 707) corresponding to the disable button 708b as having switching disabled in a memory such as the non-volatile memory 215, the RAM 214, or the like.

In step S909, the CPU 212 updates the Agile Multiband switch settings. Specifically, for example, if the enable button 710a has been pressed by the user in the detailed notification screen displayed in step S904, the CPU 212 stores the Agile Multiband switching as being set to enabled in a memory such as the non-volatile memory 215, the RAM 214, or the like. However, if the disable button 710b has been pressed by the user, the CPU 212 stores the Agile Multiband switching as being set to disabled in a memory such as the non-volatile memory 215, the RAM 214, or the like.

In step S910, the CPU 212 determines whether to connect to the pre-switch AP, or whether the post-switch AP is set as an AP for which switching is disabled. Specifically, if the connect button 709b for connecting to the pre-switch AP has been pressed by the user in the detailed notification screen displayed in the console unit 220 in step S904, the CPU 212 moves the sequence to step S911. The CPU 212 also refers to the switch settings updated in step S907, and if the switch settings for the post-switch AP are set to disabled, the sequence moves to step S911. On the other hand, if the confirmed button 709a has been pressed by the user and the switch settings for the post-switch AP are set to enabled, the CPU 212 moves the sequence to step S912.

In step S911, the CPU 212 connects to the pre-switch AP. Specifically, the CPU 212 terminates the connection with the post-switch AP, and reconnects to the pre-switch AP.

In step S912, the CPU 212 stops the display of the status notification display part displayed in the home screen. In other words, the CPU 212 performs display control for switching the display in the console unit 220 from the screen illustrated in FIG. 7A to the screen illustrated in FIG. 3A.

According to the present embodiment as described thus far, when the connection destination AP of the MFP 100 has been switched by the Agile Multiband function, a notification indicating that the connection destination AP has switched is sent. The user can therefore recognize that the connection destination AP of the MFP 100 has switched. This makes it possible to improve the convenience when the STA switches the connection destination AP.

Although the present embodiment describes an example in which the CPU 212 moves to step S807 when the connection destination change request has been received in step S806, the configuration is not limited thereto. Another example of the case where the CPU 212 has determined that a connection destination change request has been received in step S806 will be described hereinafter.

For example, if it is determined in step S806 that a connection destination change request has been received, the CPU 212 may determine whether the Agile Multiband setting is enabled before moving to the processing of step S807. If the Agile Multiband setting is determined to be enabled, the CPU 212 may move the sequence to step S807, whereas if the Agile Multiband setting is determined not to be enabled, the CPU 212 may move the sequence to step S808. Specifically, if the enable button 710a has been pressed by the user in the detailed notification screen illustrated in FIG. 7B, the CPU 212 may determine that the Agile Multiband setting is enabled. On the other hand, if the disable button 710b has been pressed by the user in the detailed notification screen illustrated in FIG. 7B, the CPU 212 may determine that the Agile Multiband setting is not enabled.

Additionally, for example, if it is determined in step S806 that a connection destination change request has been received, the CPU 212 may determine whether a setting has been made in the detailed notification screen before moving to the processing of step S807. If it is determined that a setting has not been made in the detailed notification screen, the CPU 212 may move the sequence to step S807, whereas if it is determined that a setting has been made in the detailed notification screen, the CPU 212 may move the sequence to step S808. Specifically, if the processing illustrated in FIG. 9 (e.g., steps S904 to S911) is being executed, the CPU 212 may determine that a setting has been made in the detailed notification screen. However, if the processing illustrated in FIG. 9 (e.g., steps S904 to S911) is not being executed, the CPU 212 may determine that a setting has not been made in the detailed notification screen. In other words, if a new connection destination change request is received from the AP currently connected while the detailed notification screen illustrated in FIG. 7B is displayed, the CPU 212 may perform control to respond with a rejection. This makes it possible to reliably execute the settings pertaining to Agile Multiband made by the user.

Although the foregoing has described preferred embodiments of the present invention, the present invention is not intended to be limited to the specific embodiments, and all variations that do not depart from the essential spirit of the invention are intended to be included in the scope of the present invention. Furthermore, the above-described embodiments are merely embodiments of the present invention, and different embodiments can be combined as appropriate.

Although the foregoing embodiment describes a case where the present invention is applied in an MFP as an example, the present invention is not limited to this example, and can be applied in any wireless device that (i) is connected to an AP and functions as an STA and (ii) is an electronic apparatus in which security settings can be made. In other words, the present invention can be applied in personal computers, PDAs, tablet terminals, mobile telephone terminals such as smartphones, music players, game consoles, e-book readers, smart watches, various measurement devices (sensor devices) such as thermometers and hygrometers, and the like. The present invention can also be applied in digital cameras (including still cameras, video cameras, network cameras, and security cameras), printers, scanners, and drones. The present invention can also be applied in video output devices, audio output devices (e.g., smart speakers), streaming media players, wireless LAN client devices (adapters) to which USB terminals, LAN cable terminals, or the like can be connected, and the like. Video output devices include, for example, a device that implements streaming playback, implements a mirrored display (a display in which content displayed in the electronic apparatus are also displayed in the display device), or the like by obtaining (downloading) a moving image on the Internet specified by a URL provided from an electronic apparatus and outputting the moving image to a display device connected through a video output terminal such as HDMI (registered trademark). The video output device also includes a media player such as a television, a hard disk recorder, a Blu-ray recorder, a DVD recorder, or the like, as well as a head-mounted display, a projector, a television, a display device (monitor), a signage device, or the like. The present invention can also be applied in a device capable of connecting through Wi-Fi, or what is known as a “smart home appliance”, such as an air conditioner, a refrigerator, a washing machine, a vacuum cleaner, an oven, a microwave oven, a lighting fixture, a heating appliance, a cooling appliance, or the like.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-150288, filed Sep. 15, 2023, which is hereby incorporated by reference herein in its entirety.

What is claimed is:

1. An electronic apparatus comprising:
at least one memory and at least one processor which function as:
a receiving unit configured to receive, from a first access point to which the electronic apparatus is currently connected, a change request of an access point serving as a connection destination from the first access point to a second access point;
a control unit configured to perform control to change the connection destination from the first access point to the second access point based on the change request being received by the receiving unit; and
a notification unit configured to make a notification that the connection destination has been changed when the connection destination is changed from the first access point to the second access point based on the change request.

2. The electronic apparatus according to claim 1,
wherein the at least one memory and the at least one processor a further function as a display control unit configured to perform control to display the notification made by the notification unit in a predetermined screen.

3. The electronic apparatus according to claim 2,
wherein the notification indicating that the connection destination has been changed to the second access point that has a better communication environment than the first access point.

4. The electronic apparatus according to claim 3,
wherein the display control unit performs control to display, as information about the notification, at least one of (i) identification information of the first access point and the second access point and (ii) information about the communication environment.

5. The electronic apparatus according to claim 4,
wherein the information about the communication environment is at least one of information indicating a radio wave strength, information indicating a communication band, and information indicating a congestion state.

6. The electronic apparatus according to claim 4,
wherein the identification information is at least one of information indicating a Service Set Identifier (SSID) and information indicating a Media Access Control (MAC) address.

7. The electronic apparatus according to claim 2,
wherein the at least one memory and the at least one processor further function as a setting unit configured to set whether the display control unit is to display the notification,
wherein in a case where the notification is set to not be displayed by the setting unit, the display control unit performs control such that the notification is not displayed even if the connection destination is changed based on the change request.

8. The electronic apparatus according to claim 2,
wherein the display control unit performs control not to display the notification based on a predetermined length of time passing or a predetermined operation being made by a user.

9. The electronic apparatus according to claim 2,
wherein when the notification is displayed, the control unit performs control such that the connection is not changed based on the change request even if the change request is received.

10. The electronic apparatus according to claim 2,
wherein based on the notification being displayed, the display control unit performs control to display a first interface capable of accepting an instruction to return the connection destination from the second access point, to which the connection was changed, to the first access point from before the connection was changed, and
in a case where the instruction is accepted through the first interface, the control unit performs control to change the connection destination from the second access point to the first access point.

11. The electronic apparatus according to claim 2,
wherein the display control unit performs control to display a second interface capable of accepting an instruction as to whether to change from the access point currently connected to an other access point, and
in a case where an instruction not to change from the access point currently connected to the other access point is accepted through the second interface, the control unit performs control such that the connection is not changed based on the change request.

12. The electronic apparatus according to claim 11,
wherein in a case where an instruction not to change from the access point currently connected to the other access point is accepted through the second interface, even if the change request is received, the control unit performs control to send, to the access point currently connected, a response to the change request indicating that the change is rejected, and performs control such that the connection is not changed based on the change request.

13. The electronic apparatus according to claim 11,
wherein the instruction as to whether to change from the access point currently connected to the other access point is an instruction as to whether to execute a function for switching from the access point currently connected to the other access point based on the change request.

14. The electronic apparatus according to claim 11,
wherein the second interface is an interface capable of accepting an instruction as to whether to execute the function for each of access points capable of connecting to the electronic apparatus.

15. The electronic apparatus according to claim 1,
wherein the electronic apparatus connects to access points and performs processing in accordance with an IEEE 802.11ax standard.

16. The electronic apparatus according to claim 1,
wherein the electronic apparatus can perform at least one of Orthogonal Frequency-Division Multiple Access (OFDMA)-compliant processing and Target Wake Time (TWT)-compliant processing.

17. The electronic apparatus according to claim 1,
wherein the electronic apparatus can change the connection destination to an AP using a 6 GHz band by changing the connection destination based on the change request.

18. The electronic apparatus according to claim 1, further comprising:
a printer that prints an image onto a print media.

19. A method for controlling an electronic apparatus, the method comprising:
receiving, from a first access point to which the electronic apparatus is currently connected, a change request to change a connection destination from the first access point to a second access point;
performing control to change the connection destination from the first access point to the second access point based on the change request being received; and
making a notification that the connection destination has been changed when the connection destination is changed from the first access point to the second access point based on the change request.

20. A non-transitory computer-readable storage medium storing a program configured to cause a computer to:
receive, from a first access point to which the electronic apparatus is currently connected, a change request to change a connection destination from the first access point to a second access point;
perform control to change the connection destination from the first access point to the second access point based on the change request being received; and
make a notification that the connection destination has been changed when the connection destination is changed from the first access point to the second access point based on the change request.
